(19) United States
(12) Patent Application Publication
(10) Pub. No.: US 2009/0212173 A1
(43) Pub. Date: Aug. 27, 2009

(54) CABLE MANAGEMENT DEVICE

(76) Inventor: Mark Rueckwald, Rochester, NY (US)

Correspondence Address: Stephen B. Salai, Esq.;Harter Secrest & Emery LLP, 1600 Bausch & Lomb Place, Rochester, NY, 14604-2711, US

(21) Appl. No.: 12/038,090

(22) Filed: Feb. 27, 2008

(51) Int. Cl. F16L 3/08

(52) U.S. Cl. 248/74.2

(57) ABSTRACT

A support for running wires includes at least first and second supporting hoops 12 and 14 that support the wiring that is placed within the hoops. Where more than two hoops are employed, they may be arranged either radially around the body, or longitudinally along the length of the body. The supporting hoop or hoops are attached to a plastic main body 16 having a central wire receiving channel 18 which both snaps around the support wire to provide positional stability in addition to providing a mounting point for the two supporting hoops. Preferably, the body has a longitudinally extending channel therein having resilent entry projections forming a nip for engaging the wire and securing the wire in the channel. A metal locking collar 20 is permanently mounted within the plastic main body, for example by disposing it in a slot formed within the body or by embedding it in the body when the plastic body is formed.

### CROSS-REFERENCE TO RELATED APPLICATIONS

none

### STATEMENT REGARDING FEDERALLY SPONSORED RESEARCH OR DEVELOPMENT

none

### REFERENCE TO A “SEQUENCE LISTING”

none

### TECHNICAL FIELD

The present invention relates generally to wire and cable management, and more particularly to a device for cable management in open air or drop ceilings.

### BACKGROUND OF THE INVENTION

Drop ceilings and the newer open air ceilings have become a primary means to create ceilings in both commercial locations and in residential basements. The space above such ceilings is an ideal location for installing various wiring and other services, especially with the ease at which the ceiling can be opened up to make this space accessible. Unfortunately, this ease of access and installation has created potential issues and problems. Currently, there is no cost effective or easy to implement way to support any wiring, whether it is either low voltage or high voltage in such ceiling spaces, unless you happen to be near either a wall or other building structure. Due to this limitation, it is common practice to simply lay the cabling on top of either the ceiling tiles or supporting lattices when they are in place or on any existing building structure, pipes, HVAC ducting, or the like.

To further compound this cabling routing problem, as technology grows, more and more services are installed within these spaces. With these new services, there is an ever increasing amount of wiring which must be installed to support them. Moreover, as new systems are implemented and old systems are removed and retired, an easily reconfigurable solution will become more and more relevant. The spaces above ceilings quickly become rats nests of new and old wiring.

There is, accordingly, a need for a solution to effectively manage the cabling within these building spaces.

### SUMMARY OF THE INVENTION

The present invention provides a device for routing and hanging various cables in open air spaces such as in the plenum space above a drop ceiling or an open air ceiling by attaching a plastic and metal running wire support to a support wire installed for this purpose or to an existing drop ceiling hanging metal wire support.

The device in accordance with this invention comprises three main parts:
A preferably plastic-injection molded piece consisting of a wire receiving body having a support wire engaging channel formed therein
One or more cable support hoops attached to the body, and
a metal locking device which is imbedded into the plastic body and accessible by way of the channel.

During installation, the device is simply “snapped” onto a wire such as a drop ceiling support wire at which point the metal locking device “cuts” into the support wire to prevent the device from moving longitudinally along the wire. Once installed, the plastic body secures the device to the support wire while the metal locking device provides position stability by engaging with the support wire and not allowing the device to move along the wire from its installed position.

### BRIEF DESCRIPTION OF THE DRAWING FIGURES

The novel aspects of the invention are set forth with particularity in the appended claims. The invention itself together with further objects and advantages thereof may be more readily comprehended by reference to the following detailed description of a presently preferred embodiment of the invention taken in conjunction with the accompanying drawing in which:

FIGS. 1A and 1B are a front and top views respectively of a cable management device in accordance with this invention;

FIG. 2 is a detailed view illustrating the insertion of a metal anti-sliding clip within the body of the device of FIG. 1;

FIG. 3: is a side view of the device installed on a support wire; and

FIG. 4 is a top plan view of the device of FIG. 3.

### DETAILED DESCRIPTION OF THE INVENTION

This invention allows a user to route and support any desired cabling quickly easily in any desired space or location. Once the user determines the desired path for the wiring, the next step is to determine the desired interval along this path that is sufficient for supporting the proposed wiring. After the desired path of the wiring and subsequent location of supports are known, the next step is to provide metal support wires at the various locations for the invention to clamp on to. These support wires can either be an already existing support wire for an installed drop ceiling or a support wire that is simply dropped down from any building structure at any height above the desired location. Once the support wires are either identified or installed, the cable management device is snapped onto the wires at the desired heights where they can start supporting any wires or cables that are placed within the supporting loops.

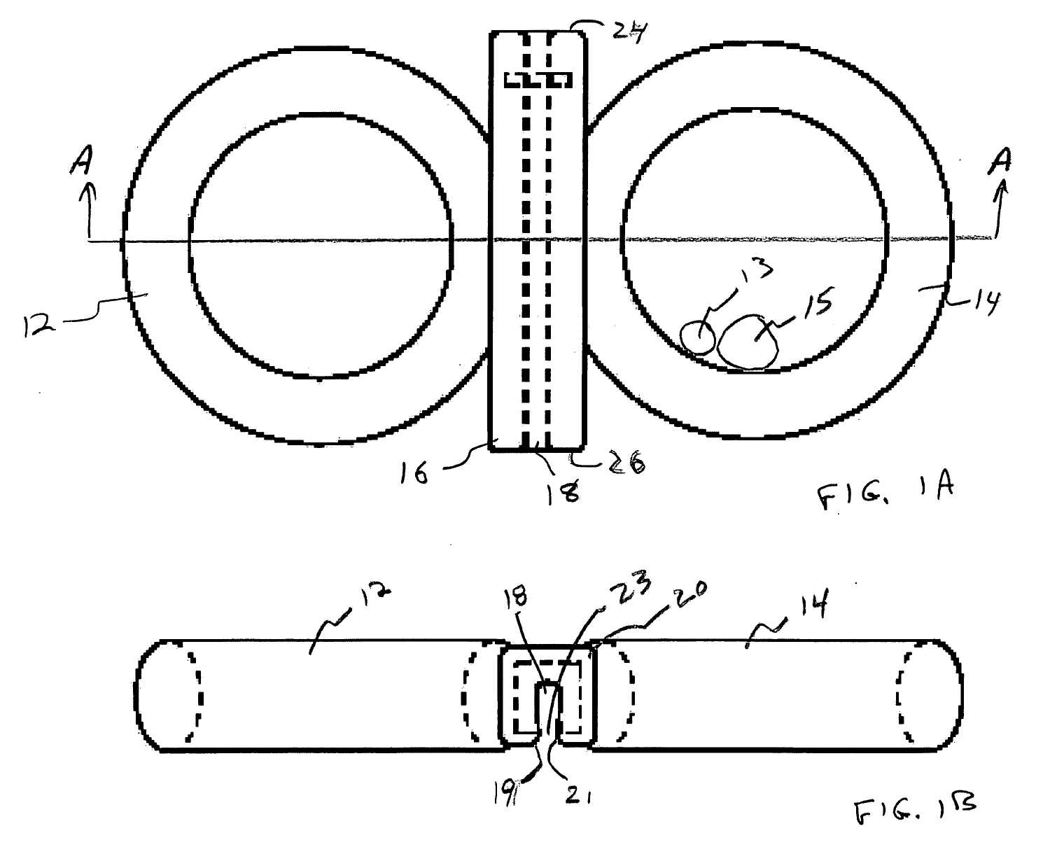

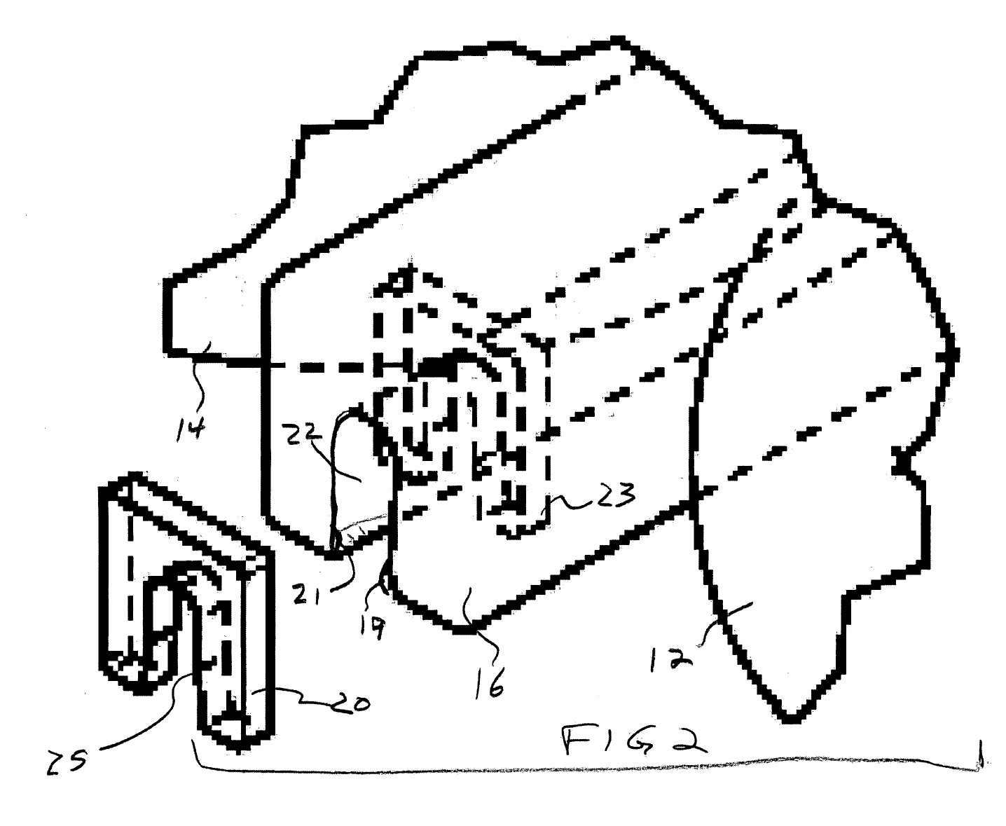

FIG. 1A is a front elevation of a presently preferred embodiment of the invention. First and second supporting hoops 12, 14 are provided that support the wiring 13, 15 that is placed within the hoops. While two hoops are illustrated, the invention contemplates that one or more hoops may be provided. Where more than two hoops are employed, they may be arranged either radially around the body, or longitudinally along the length of the body or both. The supporting hoop or hoops are attached to a plastic main body 16 having a central wire receiving channel 18 which snaps around the support wire (not shown) to provide positional stability and provides a mounting point for the two supporting hoops. Preferably, the body 16 has a longitudinally extending channel 18 therein having resilent entry projections 19, 21 forming a nip 23 for engaging the wire and securing the wire in the channel 18.

Preferably, the body 16 and hoops 12, 14 are injection molded as a single piece from plastic material such as polyethylene, polystyrene or the like. Other constructions may also be employed. The body 16 and hoops 12, 14 may be fabricated separately and connected using conventional means.

A preferably metal locking collar 20 is permanently mounted within the plastic main body 16, for example by disposing it in a slot 23 formed within the body 16 or by embedding it in the body when the plastic body is formed. Preferably, the locking collar 20 has a unshaped outer shape that matches the shape of the body. The locking collar 20 preferably has a V-shaped or tapered U-shaped groove 25 formed therein for slightly cutting into the support wire. This metal locking collar 20 grips the support wire to prevent the plastic main shaft from sliding either up or down on the support wire. The locking collar 20 is preferably made from metal or a plastic material that engages the wire sufficiently securely to prevent the device from sliding longitudinally along the wire. While a locking collar and preferably a metal locking collar are preferred, a suitable adhesive or mastic that grips the supporting wire sufficiently securely to prevent the body 16 from sliding longitudinally on the wire under the force of cables disposed within the hoops may also be placed within the channel 18 where it contacts and forms a secure connection to the wire when positioned in the channel.

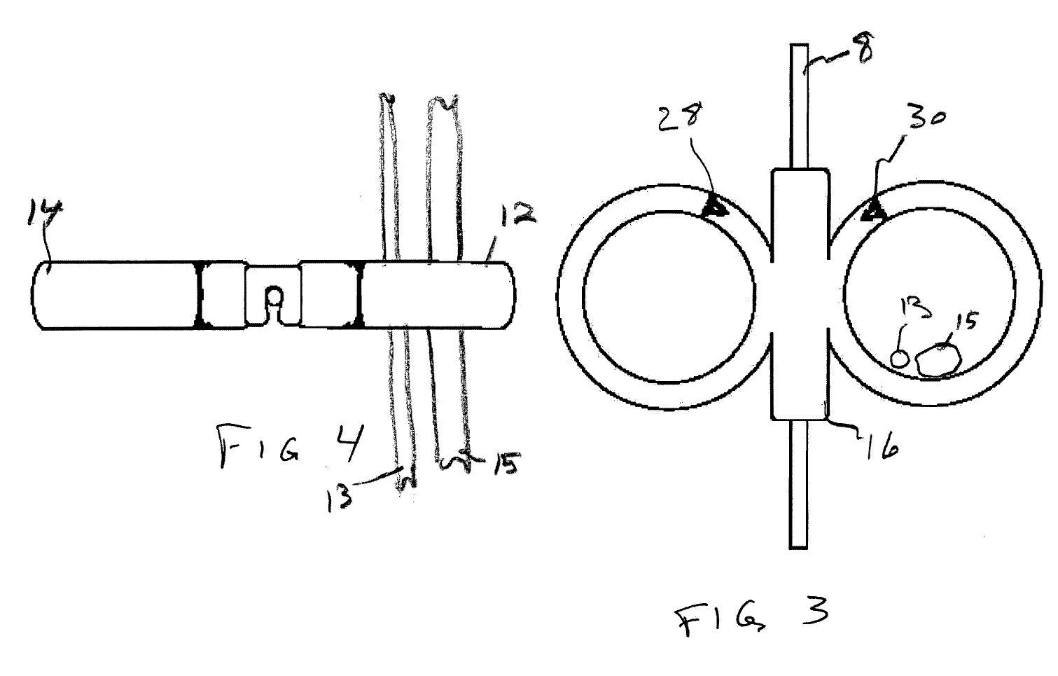

As shown in FIG. 3, the supporting hoops 12, 14 are preferably sized to receive one or more wires or cables 13, 15. In an alternative embodiment of this invention, the hoops are provided with an opening or break 28, 30 in the plastic material used to form the hoops that is normally held closed but which can be opened to allow a wire to be inserted into the hoop and then closed to retain the wire within the hoop. This process may be repeated for multiple wires. Alternatively, other structures such as a spring-loaded latch, a resilient V-shaped opening that permits wires to pass easily in one direction but inhibits passage in the other direction, or other suitable constructions may be used.

FIG. 1B is a sectional view taken along line A-A of FIG. 1 showing channel 18 formed between oppositely facing end faces 24 and 26 of wire receiving body 16. Locking collar 20 is disposed within wire receiving body 16. Preferably, the locking collar can be secured within a slot 23 formed in body 16 with an adhesive or the like, press fit into a slot, or embedded in the body 16 during a molding process.

FIG. 2 is a fragmentary perspective view showing the plastic main body 16 and the metal locking collar 20 and the metal locking collar's position within the main body 16. Preferably, slot 22 is slightly tapered from an entrance portion forming a nip between two inwardly facing resilient end projections 19, 21 and a central wire receiving portion 22. This allows the body to be snapped into position on the wire and retain the wire within the channel 22. While the locking collar 20 may in some respects assist in securing a wire within the channel 22, the primary purpose of the locking collar 20 is to engage the wire and prevent longitudinal movement of the wire receiving body 16 along the length of the wire.

FIGS. 3 and 4 are side elevation and top plan views respectively of a device in accordance with this invention mounted on a support wire 8. As has been described, wire receiving body 16 secures the device to the wire 8 while locking collar 20, not shown, fixes the device longitudinally along the length of the wire.

While the invention has been shown in connection with a presently preferred embodiment thereof, those skilled in the eye will recognize that a number of modifications and changes may be made therein without departing from the true spirit of scope of the invention which accordingly is intended to be defined solely by the appended claims.

1. A support for a running wire comprising:
an elongated body having first and second oppositely facing end surfaces having a channel formed in the body between the end surfaces for receiving a supporting wire along a longitudinal axis of the body and the supporting wire extending from the end surfaces;
a supporting wire engaging clip disposed within the elongated body and accessible by way of the channel for engaging a supporting wire and securing a supporting wire against longitudinal movement within the channel;
at least one running wire receiving hoop attached to the body for receiving and supporting a running wire extending therethrough.

2. The support for a running wire of claim 1 comprising a second wire receiving hoop attached to the body.

3. The support for a running wire of claim 1 in which the wire engaging clip comprises a U-shaped clip.

4. The support for a running wire of claim 1 in which the elongated body comprises a plastic body and the U-shaped clip is embedded in the plastic body

5. The support for a running wire of claim 1 in which the U-shaped clip comprises a metal clip.

6. The support for a running wire of claim 1 in which the running wire receiving hoop comprises a wire receiving opening permitting a wire to be passed therethrough in a first direction but retaining the wire within the hoop and preventing it from passing through the opening in the opposite direction.

7. A support for a running wire comprising:
an elongated body having first and second oppositely facing end surfaces having a channel formed in the body between the end surfaces for receiving a supporting wire along a longitudinal axis of the body and the supporting wire extending from the end surfaces;
an adhesive material disposed within the elongated body and accessible by way of the channel for engaging a supporting wire and securing a supporting wire against longitudinal movement within the channel;
at least one running wire receiving hoop attached to the body for receiving and supporting a running wire extending therethrough.

8. The support for a running wire of claim 7 in which the adhesive material comprises a mastic.
